(19) United States
(12) Patent Application Publication
(10) Pub. No.: US 2024/0203127 A1
(43) Pub. Date: Jun. 20, 2024

(54) DYNAMIC EDGE-CLOUD COLLABORATION WITH KNOWLEDGE ADAPTATION

(71) Applicant: Wyze Labs, Inc., Kirkland, WA (US)

(72) Inventors: Mohammadmahdi Kamani, Bellevue, WA (US); Lin Chen, Seattle, WA (US); Zhongwei Cheng, Bothell, WA (US); Tianqiang Liu, Kirkland, WA (US)

(21) Appl. No.: 18/554,461

(22) PCT Filed: Apr. 6, 2022
(86) PCT No.: PCT/US2022/023726

§ 371 Date: Oct. 6, 2023

Related U.S. Application Data
(60) Provisional application No. 63/171,204, filed on Apr. 6, 2021.

(51) Int. Cl. G06V 20/52; G06V 10/764; G06V 10/77; G06V 10/94; H04N 7/18

(52) U.S. Cl. CPC G06V 20/52; G06V 10/764; G06V 10/7715; G06V 10/95; H04N 7/183

(57) ABSTRACT

Introduced here are different variations of an edge-cloud collaboration framework (also called an “ECC framework”) that learns models with different levels of tradeoffs between the aforementioned objectives that tend to conflict with one another. This ECC framework—based on an adaptation of knowledge from “edge models” employed by edge devices to “cloud models” employed by a computer server system—can attempt to minimize the communication and computation costs during the inference stage while also trying to achieve the best performance possible.

### CROSS-REFERENCE TO RELATED APPLICATIONS

This application claims priority to U.S. Provisional Application No. 63/171,204, titled “Dynamic Edge-Cloud Collaboration with Knowledge Adaptation” and filed on Apr. 6, 2021, which is incorporated herein by reference in its entirety.

### TECHNICAL FIELD

Various embodiments concern surveillance systems and associated techniques for learning software-implemented models by those surveillance systems in a collaborative manner.

### BACKGROUND

The term “surveillance” refers to the monitoring of behavior, activities, and other changing information for the purpose of protecting people or items in a given environment. Generally, surveillance requires that the given environment be monitored using electronic devices such as digital cameras, lights, locks, motion detectors, and the like. Collectively, these electronic devices may be referred to as the “edge devices” of a “surveillance system” or “security system.”

One concept that is becoming more commonplace in surveillance systems is edge intelligence. Edge intelligence refers to the ability of the edge devices included in a surveillance system to process information and make decisions prior to transmission of that information elsewhere. As an example, a digital camera (or simply “camera”) may be responsible for discovering the objects that are included in digital images (or simply “images”) before those images are transmitted to a destination. The destination could be a computer server system that is responsible for further analyzing the images. Edge intelligence is commonly viewed as an alternative to cloud intelligence, where the computer server system processes the information generated by the edge devices included in the surveillance system.

Performing tasks locally—namely, on the edge devices themselves—has become increasingly popular as the information generated by the edge devices continues to increase in scale. Assume, for example, that a surveillance system that is designed to monitor a home environment includes several cameras. Each of these cameras may be able to generate high-resolution images that are several megapixels (MP) in size. While these high-resolution images provide greater insight into the home environment, the large size makes these images difficult to offload to the computer server system for analysis due to bandwidth limitations. But the large size also makes it difficult to process these images locally. For these reasons, a combination of remote and local analysis is desirable, though it is difficult to accomplish this in a resource-efficient manner.

### BRIEF DESCRIPTION OF THE DRAWINGS

FIG. 1 includes a high-level illustration of a surveillance system that includes various edge devices that are deployed throughout an environment to be surveilled.

FIG. 2 includes a high-level illustration of an edge-based inference system and a cloud-based inference system.

FIG. 3A includes a high-level illustration of an independent edge-cloud collaboration framework (also called an “ECC framework”), where the edge model implemented on the edge device performs the inference when confidence in the output is higher than a threshold while a cloud model implemented on a computer server system performs the inference when confidence in the output is lower than the threshold.

FIG. 3B includes a high-level flowchart that illustrates how confidence in the inferences produced by the edge model as output can be used to determine whether further analysis by the cloud model is necessary.

FIG. 4A includes a high-level illustration of an adaptive ECC framework, where the edge model implemented on the edge device performs the inference for samples for which confidence is higher than a threshold.

FIG. 4B includes a high-level flowchart that illustrates how confidence in the inferences produced by the edge model as output can be used to determine whether to provide feature maps to the computer server system for further analysis.

FIG. 5 is a block diagram illustrating an example of a processing system in which at least some processes described herein can be implemented.

Various features of the technology described herein will become more apparent to those skilled in the art from a study of the Detailed Description in conjunction with the drawings. Embodiments are illustrated by way of example and not limitation in the drawings. Although the drawings depict various embodiments for the purpose of illustration, those skilled in the art will recognize that alternative embodiments may be employed without departing from the principles of the technology. Accordingly, while specific embodiments are shown in the drawings, the technology is amenable to various modifications.

### DETAILED DESCRIPTION

Introduced here are approaches to developing and then deploying models that addresses the above-mentioned drawbacks of edge intelligence and cloud intelligence. Specifically, the present disclosure concerns approaches to distributing inference responsibilities across the edge devices of a surveillance system and a computer server system in order to reduce the communication and computation loads of these systems.

The massive growth in the utilization of edge intelligence has made the application of machine learning—especially in the form of software-implemented models (or simply “models”)—more ubiquitous in different domains. Despite the increasing capabilities of surveillance systems and computer server systems, due to the limited computation resources on the edge devices of the surveillance system, relying on the computationally “richer” computer server system is inevitable in most cases. Computer server systems (also called “cloud computing systems” or “cloud inference systems”) can generally achieve better performance, though the necessary communication and computation resources will increase dramatically as the number of edge devices relying on these computer server systems. Hence, there is a tradeoff in the communication resources, computation resources, and general performance of surveillance systems and associated computer server systems.

Introduced here is an edge-cloud collaboration framework (also called an “ECC framework”) that learns models with different levels of tradeoffs between the aforementioned objectives that tend to conflict with one another. This ECC framework—based on an adaptation of knowledge from “edge models” employed by the edge devices to “cloud models” employed by the computer server system—can attempt to minimize the communication and computation costs during the inference stage while also trying to achieve the best performance possible. Additionally, this ECC framework can be considered as a new technique for compression that is suitable for edge-cloud inference systems to reduce communication and computation costs.

In light of the aforementioned challenges, this ECC framework can be introduced to achieve improved tradeoffs between (i) the consumption of communication and computation resources and (ii) general performance of the surveillance system and computer server system, with a collaborative approach between the edge and cloud computing systems. Generally, the terms “edge computing system” and “edge inference system” are used to refer to the edge devices that comprise a surveillance system, and the terms “cloud computing system” and “cloud inference system” are used to refer to the computer server system itself. Meanwhile, the terms “edge-cloud inference system” and “inference system” may be used to refer to the combination of the edge computing system and computer server system. Specifically, three separate frameworks are proposed to address the aforementioned challenges, and the level of collaboration in each framework varies depending on the desired tradeoff. There are two characteristics of edge computing systems—specifically in the context of edge intelligence—that serve as motivators in the development of these frameworks.

First, in most edge computing systems, data that is representative of samples—for example, in the form of video segments or images—may not necessarily contain any targets of interest that the edge computing system is seeking to detect. These samples are mainly labeled as a normal class in the classification or background images in the object detection tasks. Accordingly, if an edge model is able to effectively detect these samples and then filter these samples before sending the data to the cloud computing system, the amount of communication and computation resources required by the cloud computing system can be significantly reduced.

Second, even if all of the data contains targets of interest, the edge model can handle parts of the detection tasks while passing the remaining detection tasks to the cloud computing system (e.g., to reduce consumption of communication and computation resources). Assume, for example, that as part of its responsibilities, the edge detection system employs edge models to compute feature maps for the samples included in the data provided as input. These feature maps could be used by the edge computing system, and these feature maps could be adapted to feature maps computed by the cloud models employed by the cloud computing system. Simply put, the feature maps computed by the edge models could be used to bypass part of the inference performed by the cloud models, so as to avoid redundant computation.

These two characteristics serve as the main motivators for two of the frameworks proposed herein. The third framework is based on a combination of the two frameworks, so as to dynamically determine “when” and “what” to send to the cloud computing system for inference. To summarize, there are several core aspects of the approach described herein:
First, distributing the inference task across the edge devices in a surveillance system in an edge-cloud collaboration manner, so as to reduce the communication and computation resources needed by the inference system as a whole;
Second, introducing knowledge adaptation to reduce the computation resources needed by the inference system by reusing feature maps generated by edge computing system for the cloud computing system; and
Third, introducing a dynamic edge-cloud collaboration framework that can act as a novel compression technique (and which has a dynamic structure instead of a static structure like traditional compression techniques).

Note that while the frameworks introduced herein may be described in the context of models employed by a given type of edge device, the frameworks may be generally applicable across various edge devices, including cameras, lights, locks, sensors, and the like. For example, for the purpose of illustration, an embodiment may be described in the context of a model that is designed to recognize instances of objects included in images that are generated by a camera. Such a model may be referred to as an “object recognition model.” But those skilled in the art will recognize that the technology may be similarly applicable to other types of models and other types of edge devices.

Moreover, embodiments may be described in the context of computer-executable instructions for the purpose of illustration. Aspects of the technology could be implemented via hardware, firmware, or software. For example, an edge device may be configured to generate data that is representative of an ambient environment and then provide the data to a model as input. The edge device can then determine, based on the output produced by the model, an appropriate course of action. If confidence in the output is sufficiently high, then the inference made by the model may be relied upon. However, if confidence in the output is low (e.g., falls beneath a threshold), then the edge device may transmit the data—or information indicative of the data—to a computer server system for further analysis. Note that confidence is simply one criterion that could be used to determine whether further analysis by the computer server system is necessary. The approach is similarly application to another criterion (or a set of criteria) that indicates whether to send the data to the computer server system.

### Terminology

References in this description to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense (i.e., in the sense of “including but not limited to”). The term “based on” is also to be construed in an inclusive sense. Thus, unless otherwise noted, the term “based on” is intended to mean “based at least in part on.”

The terms “connected,” “coupled,” and any variants thereof are intended to include any connection or coupling between objects, either direct or indirect. The connection/coupling can be physical, logical, or a combination thereof. For example, objects may be electrically or communicatively coupled to one another despite not sharing a physical connection.

The term “module” may be used to refer broadly to software, firmware, or hardware. Modules are typically functional components that generate one or more outputs based on one or more inputs. A computer program may include one or more modules. Thus, a computer program may include multiple modules that are responsible for completing different tasks or a single module that is responsible for completing all tasks.

When used in reference to a list of multiple items, the word “or” is intended to cover all of the following interpretations: any of the items in the list, all of the items in the list, and any combination of items in the list.

The sequences of steps performed in any of the processes described herein are exemplary. However, unless contrary to physical possibility, the steps may be performed in various sequences and combinations. For example, steps could be added to, or removed from, the processes described herein. Similarly, steps could be replaced or reordered. Thus, descriptions of any processes are intended to be open ended.

### Overview of Surveillance System

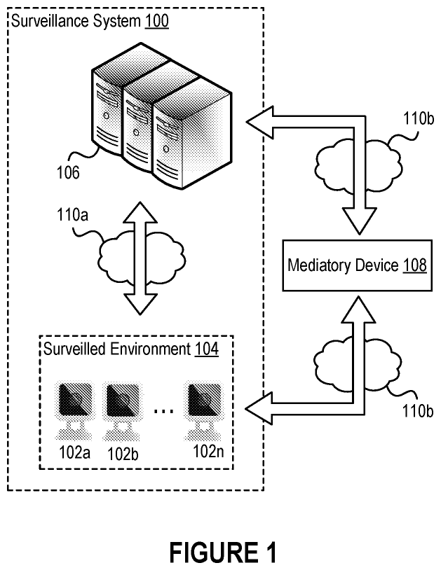

FIG. 1 includes a high-level illustration of a surveillance system 100 that includes various edge devices 102a-n that are deployed throughout an environment 104 to be surveilled. While the edge devices 102a-n in FIG. 1 are cameras, other types of edge devices could be deployed throughout the environment 104 in addition to, or instead of, cameras. Meanwhile, the environment 104 may be, for example, a home or business.

In some embodiments, these edge devices 102a-n are able to communicate directly with a server system 106 that is comprised of one or more computer servers (or simply “servers”) via a network 110a. In other embodiments, these edge devices 102a-n are able to communicate indirectly with the server system 106 via a mediatory device 108. The mediatory device 108 may be connected to the edge devices 102a-n and server system 106 via respective networks 110b-c. The networks a-c may be personal area networks (PANs), local area networks (LANs), wide area networks (WANs), metropolitan area networks (MANs), cellular networks, or the Internet. For example, the edge devices 102a-n may communicate with the mediatory device via Bluetooth®, Near Field Communication (NFC), or another short-range communication protocol, and the edge devices 102a-n may communicate with the server system 108 via the Internet.

Generally, a computer program executing on the mediatory device 108 is supported by the server system 106, and thus is able to facilitate communication with the server system 106. The mediatory device 108 could be, for example, a mobile phone, tablet computer, or base station. Thus, the mediatory device 108 may remain in the environment 104 at all times, or the mediatory device 108 may periodically enter the environment 104.

Historically, surveillance systems like the one shown in FIG. 1 operated in a “centralized” manner. That is, information generated by the edge devices 102a-n would be transmitted to the server system 106 for analysis, and the server system 106 would gain insights through analysis of the information. One benefit of this approach is that the server system 106 is generally well suited to employ computationally intensive models. However, significant communication resources are required to transmit the information to the server system 106, and the models applied by the server system—commonly called “global models”—may not be tailored for the edge devices 102a-n.

Edge intelligence has become increasingly common in an effort to address these issues. The term “edge intelligence” refers to the ability of the edge devices 102a-n to locally process the information, for example, prior to transmission of that information elsewhere. With edge intelligence, surveillance systems operate in a more “distributed” manner. In a distributed surveillance system, a global model may be created by the server system 106 and then deployed to the edge devices 102a-n. While each edge device may be permitted to tune its own version of the global model—commonly called the “local model”—based on its own data, there are downsides to this approach as discussed above. Notably, sufficient computation resources may not be available on the edge devices 102a-n in order to run the necessary models. Plus, little insight can be gained across the surveillance system 100 if each edge device implements its own local model (and therefore operates in a “siloed” manner).

### Overview of Collaborative Approach to Learning Models

Edge intelligence plays a vital role in the advancement of machine learning and computer vision applications in numerous fields. Notwithstanding the notable achievements in different domains, the computational limitations of edge computing systems are generally the main hindrance to efficient, fast utilization of models in those edge computing systems. Traditionally, the solution to this problem was to rely on a cloud computing system that has access to more computation resources in order to perform the inference task more effectively. However, relying on a cloud computing system entails higher costs in terms of communication and computation resources, as the data of interest must be provided to the cloud computing system.

Accordingly, there is a conspicuous tradeoff between (i) the consumption of communication and computation resources and (ii) general performance of the inference system, where the edge computing system and cloud computing system correspond to the extremes in this tradeoff. Edge models have lower computation cost and no communication cost with possibly the lowest performance, and cloud models offer better performance at the cost of higher communication and computation costs. The approach introduced here aims to introduce a new framework—dubbed the “ECC framework”—to fill in the gaps between edge computing systems and cloud computing systems by tracing some models with more manageable tradeoffs between (i) the consumption of communication and computation resources and (ii) general performance of the inference system.

Many compression techniques, such as knowledge distillation or quantization, have been proposed for the training of efficient and fast models. However, there is a lower bound on the ability of the corresponding algorithms in reduction of computation without compromising performance. For this reason, these compression techniques may not be suitable to run on low-powered edge devices, especially when the models to be employed by those edge devices are over-parameterized. Additionally, these compression techniques do not consider the communication inefficiencies of cloud models in their training. In the ECC framework, dynamic structures that operate with the optimal edge model can be run on the edge computing system, in conjunction with the cloud model to improve performance of that edge model while reducing communication and computation costs with respect to the inference system as a whole.

At a high level, the models can be based on adapting knowledge gained by the edge model to its counterpart cloud mark, using techniques in knowledge distillation but in a reverse direction from the student model to the teacher model. Information on teacher-to-student distillation of knowledge can be found in International Application No. PCT/US22/16117, titled “Self-Supervised Collaborative Approach to Machine Learning by Models Deployed on Edge Devices” and incorporated by reference herein in its entirety. Further, the ECC framework may use deep models for adaptation in knowledge distillation, so as to further improve distillation of knowledge from the teacher model to the student model too.

The dynamic structure of the ECC framework not only allows the edge computing system to decide “when” to send data to the cloud computing system for analysis, but also “what” data should be sent. Despite the classical compression techniques that are mainly focused on a fixed model structure to compress the data provided as input, the models employed through execution of the ECC framework can provide a dynamic structure that can be adapted based on the data provided as input. The dynamic structure efficiently reduces communication and computation costs of edge-cloud inference systems, while attempting to preserve performance of the cloud model. Hence, the ECC framework can be considered a new compression technique, in that it optimizes communication costs in addition to the tradeoff between computation cost and performance for an efficient inference system.

### A. Introduction of Compression and Knowledge Distillation

Compression techniques have been widely used in many domains to minimize the memory footprint and computation resources required for a model to run its inference.

One of the main compression techniques used in different applications is quantization, where the goal is to quantize the weights of the model to a lower bit precision in order to benefit from faster computation and lower memory usage. This process negatively impacts performance of the model since the learned weights are quantized, and therefore may not be optimal for the task at hand. Accordingly, different approaches have been employed to try to lessen (e.g., minimize) the degradation effects of quantization by implementing post-training mechanisms. Examples of post-training mechanisms include fine tuning the quantized model itself and performing quantization-aware training. Another form of compression technique stems from the idea that models are generally over-parameterized, and therefore the parameter space is highly sparse. As such, by pruning sparse weights, the model size can be reduced—leading to a decrease in the amount of computation resources required for the inference. The other main compression technique is knowledge distillation, which is discussed in greater detail below. While these different compression techniques can compress the model to a certain degree, there is a lower bound on the compression rate. Said another way, starting from a large model, these compression techniques can only compress the large model so much before performance is heavily impacted.

In knowledge distillation, instead of starting with a large model and then compressing the large model, knowledge is instead distilled from the large model (also called the “teacher model”) to a smaller model (also called the “student model”). It has been shown that this technique can boost the performance of the student model. Theoretically, the student model can be quite small; however, as the size of the student model decreases, the gap between the performance of the student and teacher models increases. Although knowledge distillation can boost the performance of the student model, this gap cannot be filled. Practically, knowledge distillation is unlikely to have a reasonable impact on the small models that are suitable for low-powered edge devices. Nonetheless, concepts from knowledge distillation can serve as inspirational motives in filling this gap by relying on a collaboration between edge and cloud models. Knowledge distillation was initially introduced for classification models by transferring knowledge from the classification output of the teacher model to its counterpart in the student model. Another approach called “FitNets” was initially introduced as a new form of knowledge distillation, where the distillation can happen between any two layers of the neural network using matching modules. Since the introduction of FitNets, various forms of knowledge distillation have been proposed.

Another related line of research relates to feature adaptation in the context of domain adaptation techniques. Domain adaptation techniques have used approaches similar to FitNets to adapt feature layers from a target domain to a source domain, in order to improve the performance of a model in the source domain. The adaptation happens mostly between the same model structures. However, there have been several recent studies of domain adaptation in edge models. Regardless, in all of these frameworks the goal is to learn a standalone model for the target domain, and therefore the feature adaptation parts are not used during inference. This is unlike the approach introduced here, where the domain is the same but the goal is to learn a model using the edge and cloud computing systems using feature adaptation.

### B. Knowledge Adaptation Across Edge and Cloud Computing Systems

An edge device can provide data that it generates to a model so as to produce an output (also referred to as a “prediction” or “inference”) that is relevant to a task. The task will depend on the nature of the edge device itself. For example, if the edge device is a camera, then the task may be to detect objects in images generated by the camera. To do this, the camera may employ an edge model that has been trained to detect those objects and then localize each detected object using a bounding box. Alternatively, the camera may transmit the images to a computer server system, and the computer server system may employ a cloud model that acts much like the edge model.

Introduced here is an ECC framework that learns models with different tradeoffs between (i) the consumption of communication and computation resources and (ii) general performance of a surveillance system, with a collaborative approach between the edge and cloud computing systems. One goal of these ECC models is to reduce the communication and computation complexities of the cloud computing system, while boosting the performance of the edge computing system. In another sense, it is desirable to compare the ECC models in terms of tradeoffs between communication resources, computation resources, and performance in order to establish the compromises suitable for different scenarios. This ECC framework provides more flexibility in choosing the appropriate approach based on the communication and computation resources that are currently available, as well as the targeted or desired performance. Three different structures are proposed for the ECC framework in greater detail below.

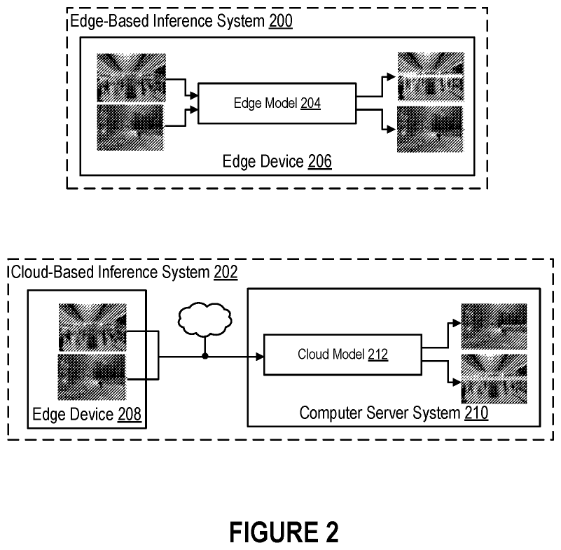

FIG. 2 includes a high-level illustration of an edge-based inference system 200 and a cloud-based inference system 202. Performing inference with the edge-based inference system 200 is less costly in terms of communication resources because the images need not leave the edge device 206 and computation resources because the edge model 204 is relatively “lightweight,” but will offer worse performance. Performing inference with the cloud-based inference system 202 is more costly in terms of communication resources because the images need to be transmitted from the edge device 208 to the computer server system 210 and computation resources because the cloud model 212 is relatively “heavyweight,” but will offer better performance.

In order to investigate the problem of distributed inference in deep neural networks, it is important to discuss the general structure and learning process of these models. Assume, for example, that there is a deep neural network model w E R^{d} that comprises [symbol] different layers w={w₁, . . . , w_{M}}. For example, the deep neural network model may be convolutional, fully connected, residual, or have any other layer architecture represented by a parameters set of wₗ, ∀l ∈ [M]. Each layer may take as input x₁, l ∈ [M], which is the output of the forward processing performed by the previous layer. As an example, each instance of forward processing may utilize the function yₗ₋₁=fₗ₋₁(xₗ₋₁; wₗ₋₁) (i.e. xₗ=yₗ₋₁).

Generally, in a supervised learning task such as classification or object detection, it is desirable to optimize a prediction mapping on a training dataset [symbol] with n samples. The mapping will transform the feature space [symbol] to a label space [symbol] —representative of class labels or object annotations, for example—where each sample point is denoted by (x⁽ⁱ⁾,y⁽ⁱ⁾ ∈ X×γ. The mapping can be represented with cascading layers of different functions fₗ(xₗ⁽ⁱ⁾; wₗ⁽ⁱ⁾, where xₗ⁽ⁱ⁾ is the input of the l-th layer generated from the input sample x⁽ⁱ⁾. The set of all of these functions is [symbol] (w)≙{f₁(·; w₁), . . . , f_{M}(·; w_{M})}. Then, the goal is to minimize the empirical risk of training data on this model:

$$ℒ ( ℱ ( 𝒲 ) ; 𝒯 ) = \frac{1}{n} {\sum }_{i = 1}^{n} ℓ ( w ; {x}_{i} , {y}_{i} ) \qquad Eq . 1$$

where [symbol] (·;·,·) is the loss function for each sample data.

The goal of either of the edge model or the cloud model is to minimize the empirical risk to achieve the best inference performance on a testing dataset, based on their models w_{edge} ∈ R^{d}^{^{e}} with Nₑ layers and w_{cloud} ∈ R^{d}^{^{c}} with N_{c} number of layers, respectively. Due to the gap between the representational capabilities of the edge and cloud models, performance on the testing dataset varies significantly. However, the limited computation resources available on the edge devices, which is generally the main bottleneck in inference systems, does not allow this gap in performance to be filled by increasing complexity of the edge model. On the other hand, merely relying on the cloud model will “cost” significantly more in comparison to purely edge-based inference systems due to the higher communication and computation requirements of cloud-based inference systems. One goal of the ECC framework is to lessen (e.g., minimize) this loss by combining the edge and cloud models such that performance is improved with the lowest viable communication and computation with the computer server system. Specifically, the ECC framework may combine the models as follows:

$$ℒ ( {ℱ}_{ECC} ( . ; {w}_{WCC} ) ; 𝒯 ) = \frac{1}{n} {\sum }_{i = 1}^{n} ℓ ( {x}_{i} , {y}_{i} ; {w}_{ECC} ) , \qquad Eq . 2$$

where [symbol] _{ecc} ⊂ [symbol] _{edge} ∪ [symbol] _{cloud} ∪ [symbol] _{adapt}, suggesting that the layers of the ECC model are representative of a subset of the union of layers from the edge model ( [symbol] _{edge}) and the cloud model ( [symbol] _{cloud}), as well as some adaptation layers ( [symbol] _{adapt}) to connect the edge and cloud models together. Note that an ECC model generally contains only a subset of those parameters rather than all of them.

### C. Overview of ECC Models

One of the primary concepts behind the ECC framework is to distribute part of the inference to the edge computing system while the remaining inference is performed by the cloud computing system. In some cases the edge computing system may be able to effectively perform the inference, while in other cases the edge computing system may utilize the resources of the cloud computing system when necessary. Accordingly, the question to be routinely answered is when to send data to the cloud computing system for a better inference using its resources. In addition to when, it must be asked what should be sent to the cloud computing system for further inference, considering that a part of inference has already been performed by the edge computing system. As further discussed below, the resulting feature maps output by the edge computing system can be utilized for inference by the cloud computing system without sending the whole data itself. This strategy not only is able to reduce communication costs, but also reduces computation costs incurred by the cloud computing system. Moreover, since data for which inferences are to be made does not need to be directly sent to the cloud computing system, privacy of the data can be protected on the corresponding edge devices. Three different structures for inference using edge and cloud models involved in the ECC framework are proposed below—namely, the independent ECC framework, adaptive ECC framework, and dynamic ECC framework. Using these variants of the ECC framework, it is possible to train models with different levels of compromises in terms of communication resources, computation resources, and performance, and a selection can be made from among these variants based on the resources available to each surveillance system.

### D. Independent ECC Framework

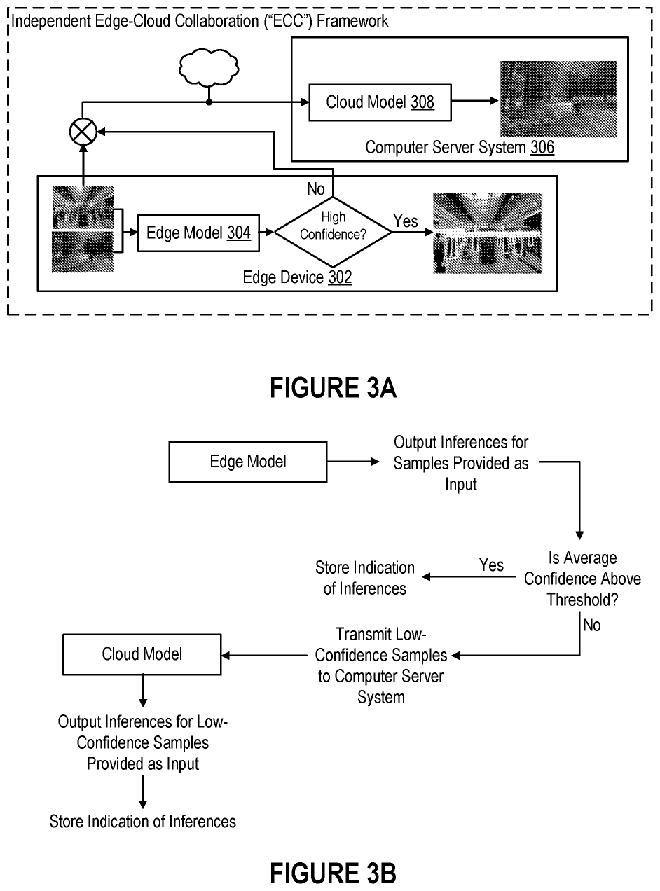

In this structure, the edge model is used mainly as a filtration mechanism to decide when the data provided as input should be sent to the cloud computing system for further inference. This determination can be based on the confidence that the edge device has in the inference output by the edge model. FIG. 3A includes a high-level illustration of an independent ECC framework, where the edge model 304 implemented on the edge device 302 performs the inference when confidence in the output is higher than a threshold while a cloud model 308 implemented on a computer server system 306 performs the inference when confidence in the output is lower than the threshold. Said another way, the edge device 302 can send the input data—in this case, images—to the computer server system 306 for an improved inference with a more computationally intense model in the event that confidence falls beneath the threshold. When confidence in the output is higher than the threshold, the edge device 302 can indicate that the output is an appropriate inference in a data structure. For example, the edge device 302 may indicate that the output is an appropriate inference by specifying as much in a data structure maintained in its memory.

In this structure, the input data can be sent as a whole to computer server system 306 for inference, should the edge device 302 decide to send it to the computer server system 306 based on the output produced by the edge model 304. Two cases can be considered where the edge model 304 performs the inference by itself, and therefore the edge device 302 does not transmit the input data to the computer server system 306.

First, inference may be performed solely by the edge model 304 when confidence in the output for a given sample is sufficiently high. Confidence is deemed to be sufficiently high when a metric indicative of the confidence exceeds a threshold. This threshold could be programmed in the memory of the edge device 302. While the threshold is generally static, the threshold could vary based on the nature of the inference. For example, the threshold for a classification task may be different than the threshold for an object detection task. Similarly, the nature of the confidence itself could vary. For example, this confidence could be class confidence in a classification task, or this confidence could be the average of objects' confidence detected in a given image for an object detection task.

Another—perhaps more important—case happens when the edge device 302 generates samples that do not contain any information to be detected. In this scenario, those samples do not contain any classes or objects of interest, and therefore can be discarded by the edge device 302 to save on communication and computation resources. This scenario is common in most edge-based surveillance systems, and forwarding such samples requires (and in some cases exhausts) the communication resources or computation resources that are available. From another point of view, this scenario can be considered as an instance of the aforementioned first case, except in this scenario, these samples may be considered as a separate class (e.g., a normal class for a classification task) or separate object (e.g., a background object in an object detection task). When confidence in the output produced by the edge model 304 is high for this separate class or separate object, the edge model 304 can conclude the inference. Otherwise, the edge device 302 can transmit the sample to the computer server system 306 for further inference results. Thus, when implemented in accordance with the independent framework, the ECC model can implement the following rule:

$${ℱ}_{{ECC}_{I}} ( x ; {w}_{{ECC}_{I}} ) = \{ \begin{matrix}{ℱ}_{edge} ( x ; {w}_{edge} ) ; {C}_{edge} \geq {c}_{1} \\ {ℱ}_{cloud} ( x ; {w}_{cloud} ) ; Otherwise\end{matrix} \qquad Eq . 3$$

where C_{edge} is the confidence of the edge model 304 in the normal class or background object for their respective tasks and c₁ is the designated threshold.

FIG. 3B includes a high-level flowchart that illustrates how confidence in the inferences produced by the edge model as output can be used to determine whether further analysis by the cloud model is necessary. As shown in FIG. 3B, the appropriate inference for a given sample can be determined as part of a multi-stage process in which the edge model is initially applied to the given sample to produce a first inference and then the cloud model is applied to the given sample to produce a second inference if confidence in the first inference falls beneath a threshold. In scenarios where confidence in the first inference is sufficiently high (e.g., exceeds the threshold), then an indication of the inference can be stored in a data structure. The data structure could be maintained in memory of the edge device, or the edge device could transmit the first inference (or information indicative of the first inference) elsewhere. For example, the data structure could be maintained in memory of the computer server system, or the data structure could be maintained in memory of a mediatory device. Specifically, the data structure could be managed by a computer program executing on the mediatory device, and the computer program may monitor inferences produced by the edge devices of a surveillance system, as well as inferences produced on behalf of the edge devices of the surveillance system by the computer server system.

### E. Adaptive ECC Framework

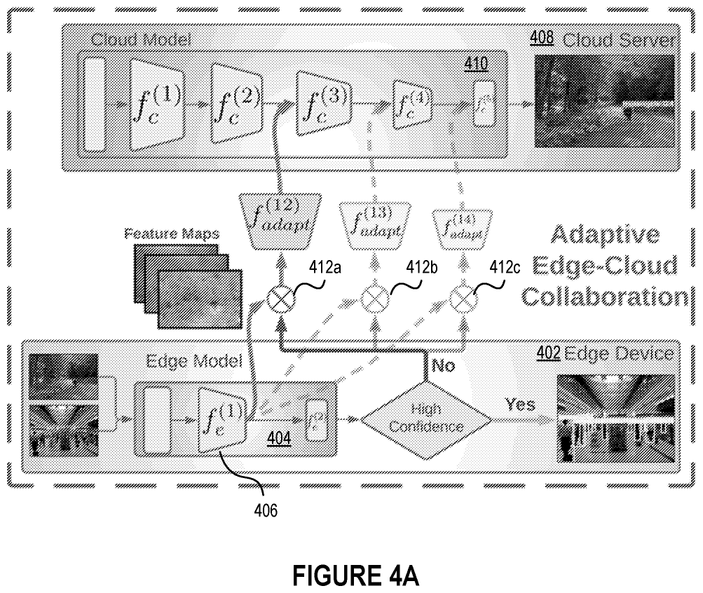

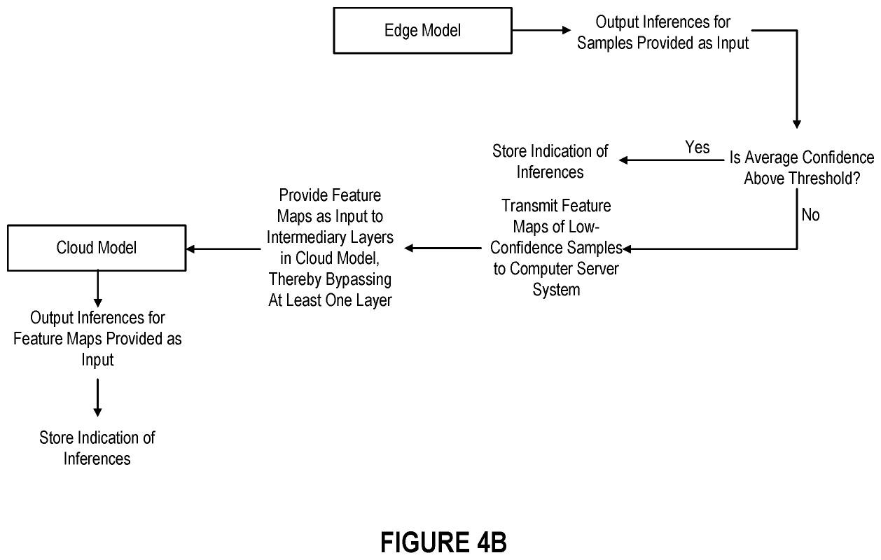

In this structure, the primary goal is to adapt feature maps of the edge model to corresponding feature maps on the cloud model. In doing so, these adapted feature maps from the edge device can be used as an input for designated layers (e.g., intermediary layers) in the cloud model, and therefore one or more layers in the cloud model can be bypassed—resulting in lower computation costs overall. FIG. 4A includes a high-level illustration of an adaptive ECC framework, where the edge model 404 implemented on the edge device 402 performs the inference for samples for which confidence is higher than a threshold. However, if confidence is below the threshold, then the edge device 402 can send its feature map 406 to the cloud model 410 implemented on the computer server system 408. As shown in FIG. 4A, the cloud model 410 can use the feature map as an input for one of its middle layers. Adaptation could be performed between any two layers of the edge and cloud models 404, 410, and adaptation is normally performed by the computer server system 408 for resource management purposes.

The output of the inference produced by the edge model 404 may still be used for filtration as discussed above with respect to the independent ECC framework, but in this scenario, the feature map is transmitted to the computer server system 408 rather than the sample itself. The adaptation process—using adaptation modules 412a-c corresponding to the different layers of the cloud model 410—can be performed by the computer server system 408. In this structure, the training of the edge and cloud models 404, 410, as well as the adaptation modules 412a-c, can be coupled together.

In this structure, the adaptation modules 412a-c can be used to transfer feature maps generated by the edge model 404 to corresponding feature maps of the cloud model 410 through the addition of layers. In FIG. 4A, these layers are denoted by [symbol] _{adapt}^{(mn)} and parameterized by W_{adapt}^{(mn)}, where m is the index of the feature map layer in the edge model 404 and n is the index of the feature map in the cloud model 410. These auxiliary layers can adapt the output of the m-th layer of the edge model (y_{edge}^{(m)} to the output of the n-th layer of the cloud model (y_{cloud}⁽ⁿ⁾ as follows:

$${y}_{adapt}^{( n )} = {ℱ}_{adapt}^{( m n )} ( {y}_{edge}^{( m )} ; {w}_{adapt}^{( m n )} ) . \qquad Eq . 4$$

At a high level, the objective is to minimize the distance between the feature maps of y_{adapt}⁽ⁿ⁾ and Y_{cloud}⁽ⁿ⁾, where knowledge distillation approaches are used during training to achieve this goal. During the inference, similar to the independent ECC framework, a threshold c₁ can be used to filter samples. But instead of transmitting the samples (e.g., the entire image if the edge device 402 is a camera), the feature maps can instead be transmitted to the computer server system 408. Thus, when implemented in accordance with the adaptive framework, the ECC model can implement the following rule:

$${ℱ}_{{ECC}_{A}} ( x ; {w}_{{ECC}_{A}} ) = \{ \begin{matrix}{ℱ}_{edge} ( x ; {w}_{edge} ) ; {C}_{edge} \geq {c}_{1} \\ {ℱ}_{cloud}^{( l > n )} ( {y}_{adapt}^{( n )} ; {w}_{cloud}^{( l > n )} ) ; Otherwise\end{matrix} \qquad Eq . 5$$

where y_{adapt}⁽ⁿ⁾ is calculated from the input data and the resulting feature map of the edge model 404, and where

$${ℱ}_{cloud}^{( l > n )} = \{ {f}_{cloud}^{( n )} ( . ; {w}_{cloud}^{( n )} ) , … , {f}_{cloud}^{( {N}_{c} )} ( . ; {w}_{cloud}^{( {N}_{c} )} ) \}$$

and

$${w}_{cloud}^{( l > n )} = \{ {w}_{cloud}^{( n )} , … , {w}_{cloud}^{( {N}_{c} )} \}$$

are layer functions and corresponding parameters after the n-th layer in the cloud model 410.

FIG. 4B includes a high-level flowchart that illustrates how confidence in the inferences produced by the edge model as output can be used to determine whether to provide feature maps to the computer server system for further analysis. The process shown in FIG. 4B may be largely similar to the process shown in FIG. 3B. Here, however, feature maps are provided to the computer server system rather than the samples themselves. These feature maps can be provided to designated layers of the cloud model as input. Generally, the designated layers are intermediary layers of the cloud model, which allows at least one layer of the cloud model to be bypassed during the inference stage.

### F. Knowledge Distillation and Adaptation

Traditionally, there are two main approaches for knowledge distillation: (i) distilling knowledge through confidence scores by adjusting the temperature in the Softmax function employed by a neural network and (ii) distilling knowledge using hint layers and feature imitation for different layers of a neural network. In the ECC framework, the focus is on the latter since it can be used for knowledge adaptation too. However, the former approach could still be used to boost performance of an edge model. For the hint layers, traditional approaches use a simple adaptation module such as one layer of a fully connected neural network or one layer of a convolutional neural network, to mainly focus on the student module's parameters rather than the adaptation module itself. However, the present disclosure proposes to use deep neural networks as the residual layers or bottleneck layers, similar to those used in domain adaptation and variational autoencoders. This is done for several reasons. First, performance of the student model can be boosted more using deep neural networks than simple neural networks. Second, the adaptation modules can be used for knowledge adaptation as mentioned above, and a deep neural network can achieve better performance in adapting feature maps from an edge model to a cloud model.

To distill knowledge from the cloud model, the computer server system can use the binary cross-entropy loss between the adapted feature map of the m-th layer of the edge model and the feature map on the n-th layer of the cloud model as follows:

$${ℒ}_{KD} ( {ℱ}_{ECC} ; 𝒯 ) = B C E ( σ ( {y}_{cloud}^{( n )} ) , σ ( {y}_{adapt}^{( n )} ) ) , \qquad Eq . 6$$

where σ(x)=1/(1+e^{-x}) is a Sigmoid function to normalize the values of each pixel in the feature maps of the cloud model and adaptation models employed by the adaptation modules. While this example presumes that the input samples are images, this approach to knowledge distillation may be similarly applicable to other types of inputs. This loss can be used to update the adaptation module parameters w_{adapt}^{(mn)}, as well as the edge model parameters on or before the m-th layer w_{edge}^{(lsm)}. In conjunction with the main learning objective defined for the edge model, the edge model parameters and adaptation model parameters can be optimized.

### G. Dynamic ECC Framework

Generally, performance of the independent ECC framework is nearly as good as if the cloud model were solely responsible for producing inferences. However, the computation cost can still be a burden in some scenarios, and therefore might delay the inference time since the input data must pass through the edge and cloud models for some samples. On the other hand, the adaptive ECC framework can efficiently reduce computation costs by sacrificing some performance measures compared to the cloud model. By combining the independent and adaptive ECC frameworks, the benefits of both approaches can be achieved. To accomplish this, a mechanism must be implemented that is able to decide when to use each ECC model dynamically on different input data. One approach is to use the confidence level of the inference result output by the edge model to decide between these two ECC models on a per-sample basis. Using the dynamic ECC framework, the computer server system can learn models with different levels of tradeoffs between communication resources, computation resources, and performance of edge-cloud models. By finding the optimal thresholds for this transition, the structure of the dynamic ECC model can be defined as follows:

$${ℱ}_{{ECC}_{D}} ( x ; {w}_{{ECC}_{D}} ) = \{ \begin{matrix}{ℱ}_{edge} ( x ; {w}_{edge} ) ; {C}_{edge} \geq {c}_{1} \\ {ℱ}_{cloud}^{( l > n )} ( {y}_{adapt}^{( n )} ; {w}_{cloud}^{( l > n )} ) ; {c}_{2} \leq {C}_{edge} \leq {c}_{1} \\ {ℱ}_{cloud} ( x ; {w}_{cloud} ) ; Otherwise\end{matrix} . \qquad Eq . 7$$

Accordingly, the edge device can initially apply a model to samples that are generated through surveillance of an environment, so as to produce outputs that are representative of inferences made in relation to the samples. The nature of the samples can vary based on the nature of the edge device. As an example, if the edge device is a camera, then the samples may be images. Then, the edge device can determine whether confidence in each of the outputs exceeds a threshold. For each output for which the confidence does not exceed the threshold, the edge device can cause transmission of (i) the corresponding sample or (ii) information related to the corresponding sample to a computer server system for analysis. For example, the edge device could transmit an image generated by its camera, or the edge device could transmit a feature map that is representative of the image generated by its camera.

### H. Additional Features

Several parts of the ECC framework can change (e.g., be tuned) based on the problem. As an example, the adaptation layer could be changed based on the problem. This could happen from any layer of the edge model to any layer of the cloud model. However, theoretically, as layers closer to the end of the edge model and layers closer to the beginning of the cloud model are chosen, the model will get closer to the ECC model—and therefore offer better performance but have higher communication and computation costs.

The structure and size of the adaptation modules can vary, and these variations could potentially affect overall performance of the ECC model depending on the problem at hand. Similarly, the thresholds for each ECC framework could be tuned based on the problem, and thus may not be set beforehand. Said another way, the thresholds for each ECC framework may not be predetermined but could instead be dynamically determined based on the problem.

Generally, the training procedure for the ECC model is rather standard. For instance, the training procedure may start with training the edge model with knowledge distillation and then fine tuning with adaptation modules afterwards. Alternatively, the edge model and adaptation modules could be trained together.

### Processing System

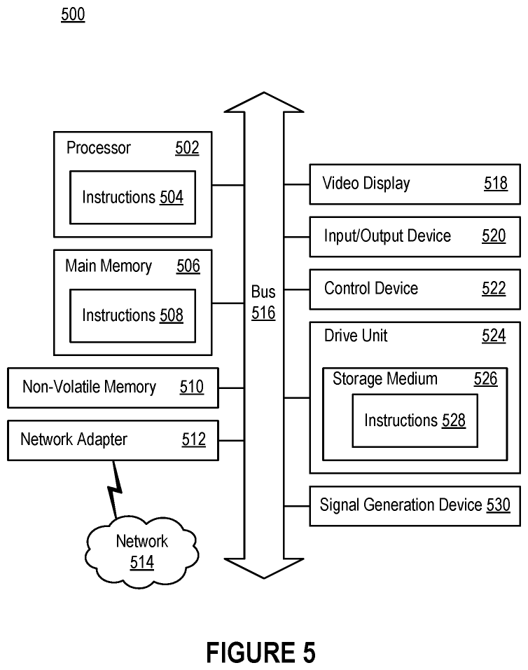

FIG. 5 is a block diagram illustrating an example of a processing system 500 in which at least some processes described herein can be implemented. For example, components of the processing system 500 may be hosted on an edge device, mediatory device, or computer server system.

The processing system 500 may include one or more central processing units (“processors”) 502, main memory 506, non-volatile memory 510, network adapter 512, video display 518, input/output devices 520, control device 522 (e.g., a keyboard or pointing device), drive unit 524 including a storage medium 526, and signal generation device 530 that are communicatively connected to a bus 516. The bus 516 is illustrated as an abstraction that represents one or more physical buses or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), Inter-Integrated Circuit (I²C) bus, or an Institute of Electrical and Electronics Engineers (IEEE) standard 1394 bus (also referred to as “Firewire”).

The processing system 500 may share a similar processor architecture as that of a desktop computer, tablet computer, mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 500.

While the main memory 506, non-volatile memory 510, and storage medium 526 are shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the processing system 500.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in an electronic device. When read and executed by the processors 502, the instruction(s) cause the processing system 500 to perform operations to execute elements involving the various aspects of the present disclosure.

Moreover, while embodiments have been described in the context of fully functioning electronic devices, those skilled in the art will appreciate that some aspects of the technology are capable of being distributed as a program product in a variety of forms. The present disclosure applies regardless of the particular type of machine- or computer-readable media used to effect distribution.

Further examples of machine- and computer-readable media include recordable-type media, such as volatile and non-volatile memory devices 510, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 512 enables the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

The network adapter 512 may include a firewall that governs and/or manages permission to access/proxy data in a network. The firewall may also track varying levels of trust between different machines and/or applications. The firewall can be any number of modules having any combination of hardware, firmware, or software components able to enforce a predetermined set of access rights between a set of machines and applications, machines and machines, or applications and applications (e.g., to regulate the flow of traffic and resource sharing between these entities). The firewall may additionally manage and/or have access to an access control list that details permissions including the access and operation rights of an object by an individual, a machine, or an application, and the circumstances under which the permission rights stand.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A surveillance system comprising:
a camera that is configured to:
generate a first series of images of an environment to be surveilled,
apply a first model to each image in the first series of images, so as to produce a first series of outputs, and
for each output in the first series of outputs,
determine whether confidence in that output exceeds a threshold, and
cause transmission of that output to a server system in response to a determination that the confidence does not exceed the threshold; and
the server system that is configured to:
receive a second series of images from the camera,
wherein the second series of images is representative of a subset of the first series of images, and
apply a second model to each image in the second series of images, so as to produce a second series of outputs.

2. The surveillance system of claim 1,
wherein each output in the first series of outputs is representative of an inference made by the first model regarding content of a corresponding image in the first series of images, and
wherein each output in the second series of outputs is representative of an inference made by the second model regarding content of a corresponding image in the second series of images.

3. The surveillance system of claim 1, wherein the camera is further configured to:
for each output in the first series of outputs,
indicate that output is an appropriate inference in a data structure in response to a determination that the confidence does exceed the threshold.

4. The surveillance system of claim 1,
wherein the server system is further configured to:
cause transmission of the second series of outputs to the camera; and
wherein the camera is further configured to:
establish that an activity or an object of interest is included in at least one image in the first series of images based on an analysis of (i) confident outputs in the first series of outputs and (ii) the second series of outputs, and
cause a notification that specifies the activity or the object of interest to be presented by a computer program executing on a mediatory device.

5. The surveillance system of claim 1,
wherein the server system is further configured to:
cause transmission of the second series of outputs to a computer program executing on a mediatory device; and
wherein the camera is further configured to:
cause transmission of confident outputs in the first series of outputs to the computer program executing on the mediatory device.

6. The surveillance system of claim 1, wherein the first model requires fewer computational resources than the second model to produce an output when applied to a given image.

7. The surveillance system of claim 1, wherein the threshold is programmed in memory of the camera.

8. A surveillance system comprising:
a camera that is configured to:
generate a series of images of an environment to be surveilled,
apply a first model to each image in the series of images, so as to produce a first series of outputs, and
for each output in the first series of outputs,
determine whether confidence in that output exceeds a threshold, and
cause transmission of a feature map corresponding to that output to a server system in response to a determination that the confidence does not exceed the threshold; and
the server system that is configured to:
receive a series of feature maps from the camera,
wherein the series of feature maps corresponds to a subset of the series of images, and
for each feature map of the series of feature maps,
providing that feature map as input to a second model, so as to produce a second series of outputs.

9. The surveillance system of claim 8, wherein each feature map is provided as input to a middle layer of the second model.

10. The surveillance system of claim 8, wherein the first and second models are classification models.

11. The surveillance system of claim 8, wherein the first and second models are object detection models.

12. A method performed by an edge device that generates samples while surveilling an environment, the method comprising:
applying a model to the samples to produce outputs,
wherein each output is representative of an inference made in relation to a corresponding sample;
determining whether confidence in each of the outputs exceeds a threshold; and
for each output for which the confidence does not exceed the threshold,
causing transmission of (i) the corresponding sample or (ii) information regarding the corresponding sample to a server system for analysis.

13. The method of claim 12, wherein the edge device is a camera, and wherein the model is trained to detect instances of an object in images.

14. The method of claim 12, wherein the information includes a feature map derived for the corresponding sample.

15. The method of claim 12, wherein said applying, said determining, and said causing are performed in real time as the samples are generated by the edge device.

16. A method performed by a server system, the method comprising:
receiving a feature map from an edge device that generates a sample while surveilling an environment,
wherein the feature map is generated by a first model upon being applied to the sample;
providing the feature map to an intermediate layer of a second model as input, so as to produce an output that is representative of an inference made in relation to the sample; and
storing an indication of the inference in a data structure.

17. The method of claim 16, wherein the data structure is maintained in memory of the server system.

18. The method of claim 16, wherein the sample is representative of a digital image of the environment.
